(19) United States
(12) Patent Application Publication
(10) Pub. No.: US 2026/0332926 A1
(43) Pub. Date: Oct. 22, 2026

(54) Speaker box

(71) Applicant: AAC Microtech (Changzhou) Co., Ltd., Changzhou City, Jiangsu Province (CN)

(72) Inventors: Zhang Ren, Shenzhen (CN); Zhiwei Zhong, Shenzhen (CN)

(21) Appl. No.: 17/913,829

(22) PCT Filed: Jul. 20, 2022
(86) PCT No.: PCT/CN2022/106624

§ 371 Date: Feb. 28, 2026

(30) Foreign Application Priority Data
Jun. 29, 2022 (CN) 202221658223.3

(51) Int. Cl. H04R 1/02; H04R 7/04; H04R 7/18; H04R 9/02; H04R 9/04

(52) U.S. Cl. CPC H04R 1/025; H04R 7/04; H04R 7/18; H04R 9/025; H04R 9/045; H04R 2307/204; H04R 2307/207

(57) ABSTRACT

A speaker box provided in the present disclosure includes a housing, a vibration unit and a magnet unit. The vibration unit includes a first diaphragm fixed to the housing, a coil fixed to the first diaphragm, and a coil frame configured to suspend the coil. The coil frame includes a plate portion in a ring shape fixed to the first diaphragm, a first support portion bending from an inner edge of the plate portion, and a second support portion bending from an outer edge of the plate portion. The vibration unit further includes a steel ring fixed the housing and surrounding the coil frame, and a second diaphragm connecting the steel ring and an end of the coil frame away from the first diaphragm; the steel ring, the second diaphragm and the coil frame are integrally molded. Not only simplify the assembly procedures and reduce the assembly complexity, but also avoid the risk of that the glue overflows to the second diaphragm in the related art, thus effectively improving the reliability of the second diaphragm and the acoustic performance of the speaker box.

### TECHNICAL FIELD

The present disclosure relates to electro-acoustic transducers, especially relates to a speaker box applied in mobile device.

### BACKGROUND

With the development of electronic technologies, portable consumable electronic products are increasingly popular, such as mobile phone or other audio entertainment equipment, in which a speaker box is generally used for the playback of audio signal. Generally, the speaker box is one of the essential conditions of realizing the function of high quality music.

### SUMMARY

### Technical Problem

In related art, a vibration unit of the speaker box includes a first diaphragm used for generating sound signal, a coil fixed to the first diaphragm, a coil frame supporting the coil, a second diaphragm fixed to the second diaphragm and a FPC fixed to the second diaphragm to electrically activate the coil. However, the speaker box includes excessive components which may complex the assembly process. Besides, the FPC and the second diaphragm are fixed via glue, thus requiring a relatively wide glue area. During the gluing process, the glue is prone to overflow to the second diaphragm to reduce its reliability.

Therefore, it is necessary to provide an improved speaker box to overcome the problems mentioned above.

### SOLUTIONS FOR THE TECHNICAL PROBLEM

### Technical Solutions

Based on the technical problem above, the present disclosure provides a speaker box with higher vibration reliability and higher stability.

To achieve the objective above, the speaker box includes a housing with a receiving space; a magnet unit having a magnetic gap, including: a yoke fixed to the housing; and a main magnet fixed to the yoke; a vibration unit received in the receiving space, including: a first diaphragm fixed to the housing; a coil fixed to the first diaphragm and inserted in the magnetic gap; a coil frame configured to suspend the coil, including: a plate portion in a ring shape fixed to the first diaphragm; a first support portion bending from an inner edge of the plate portion and configured to suspend the coil inside the magnetic gap; and a second support portion bending from an outer edge of the plate portion; a steel ring fixed the housing and surrounding the second support portion; and a second diaphragm connecting the steel ring and an end of the second support portion away from the first diaphragm; wherein the steel ring, the second diaphragm and the coil frame are integrally molded.

Further, an inner edge of the second diaphragm is fixed to the end of the second support portion away from the first diaphragm, and an outer edge of the second diaphragm is fixed to the steel ring.

Further, the speaker box includes a FPC electrically connecting the coil and an outer circuit and fixed to a side of the steel ring facing the first diaphragm.

Further, the steel ring includes a first horizontal portion fixed to the housing and a first bending portion bending from an inner edge of the first horizontal portion and extending away from the first diaphragm; the outer edge of the second diaphragm is fixed to the first bending portion; the FPC is fixed to a side of the first horizontal portion facing the first diaphragm.

Further, the FPC includes a first elastic portion fixed to the steel ring, a second elastic portion spaced apart from the first elastic portion, a first electrical connection portion extending from the first elastic portion and a second electrical connection portion extending from the second elastic portion, the second electrical connection portion is electrically connected with the coil.

Further, a first through hole is provided on the second support portion of the coil frame; the second electrical connection portion extends through the first through hole to be electrically connected with the coil.

Further, the first diaphragm includes a central diaphragm located in a central position, a dome surrounding the central diaphragm and a side diaphragm surrounding the dome; the side diaphragm is fixed to the housing; the plate portion of the coil frame is fixed to a side of the dome facing the coil.

Further, the magnet unit includes a side magnet spaced apart from the main magnet to form the magnetic gap; the central diaphragm is fixed to a side of the main magnet away from the yoke.

Further, the housing is in a rectangle shape, the second diaphragm is arranged along a short axis of the housing.

Further, the steel ring, the second diaphragm and the coil frame are integrally thermal press molded.

### BENEFICIAL EFFECTS OF THE PRESENT DISCLOSURE

### Beneficial Effects

Compared with the related art, in the speaker box of the present disclosure, the steel ring, the second diaphragm and the coil frame are integrally thermal press molded to form a single component in the assembly process of the speaker box. In this way, not only simplify the assembly procedures, but also avoid the risk of that the glue overflows to the second diaphragm in the related art, thus effectively improving the reliability of the second diaphragm and the acoustic performance of the speaker box.

### BRIEF DESCRIPTION OF THE DRAWINGS

### Description of the Drawings

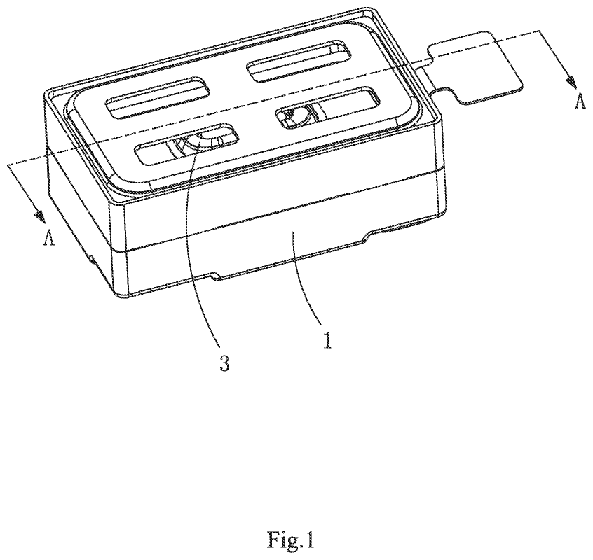

FIG. 1 is an isometric view of a speaker box in accordance with an exemplary embodiment of the present disclosure.

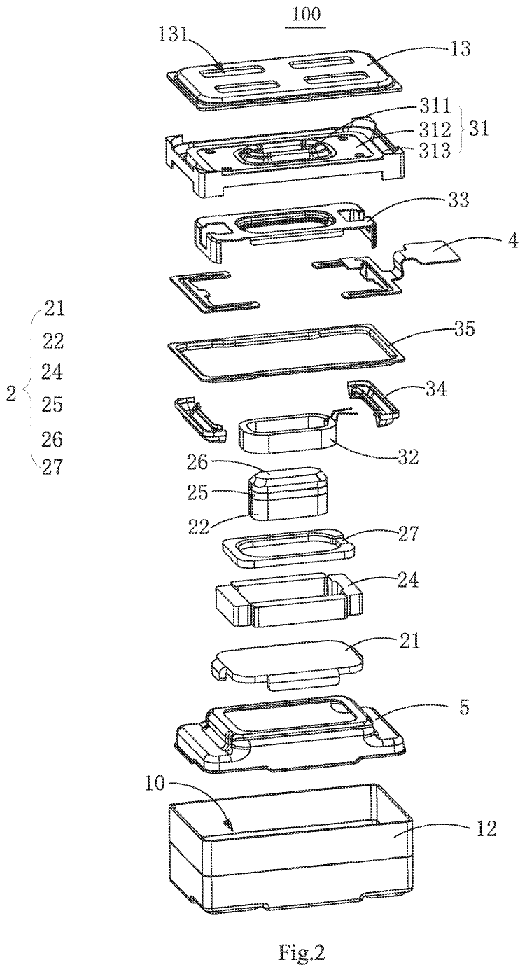

FIG. 2 is an exploded view of the speaker box in FIG. 1.

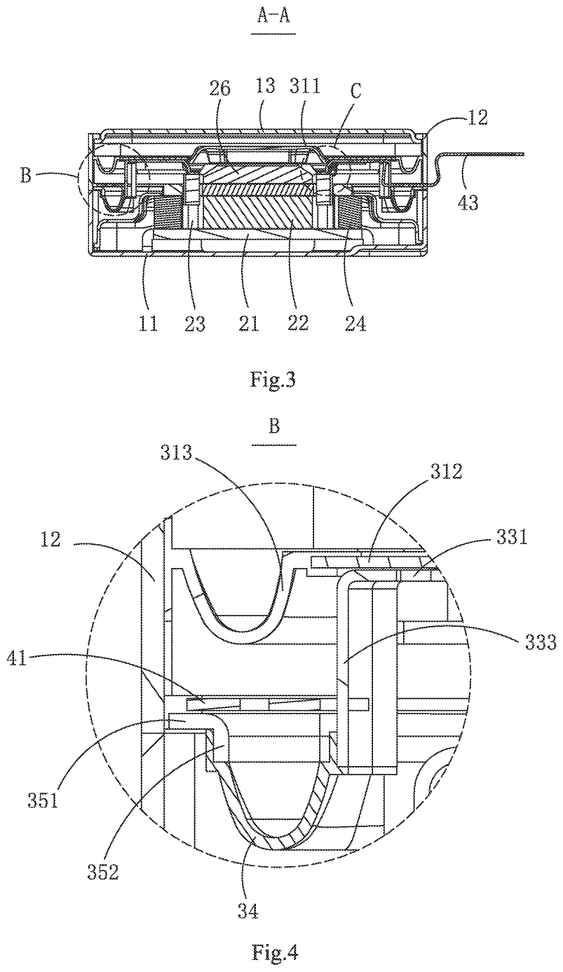

FIG. 3 is a cross-sectional view of the speaker box taken along line A-A in FIG. 1.

FIG. 4 is an enlarged view of part B in FIG. 3.

FIG. 5 is an enlarged view of part C in FIG. 3.

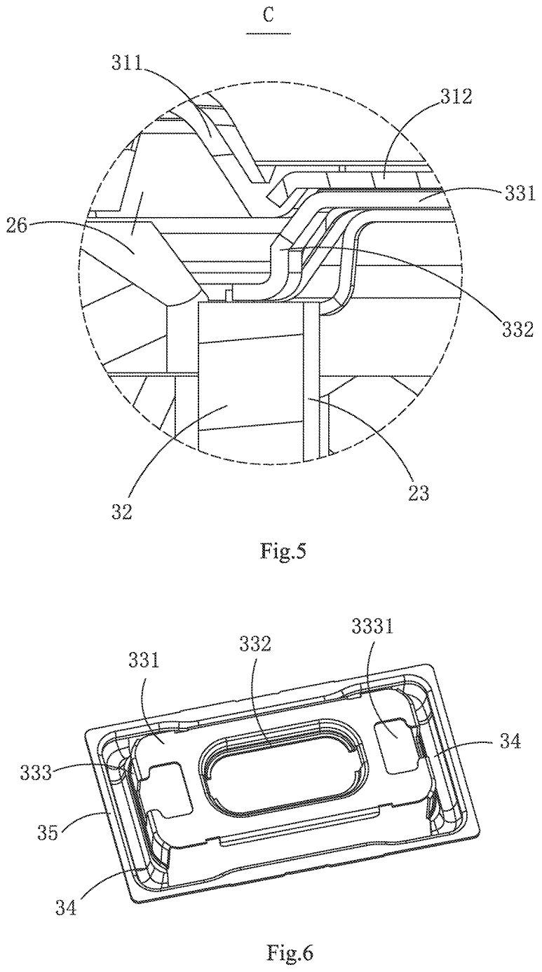

FIG. 6 is an isometric view of an assembly of a steel ring, a second diaphragm and a coil frame of the speaker box in FIG. 1.

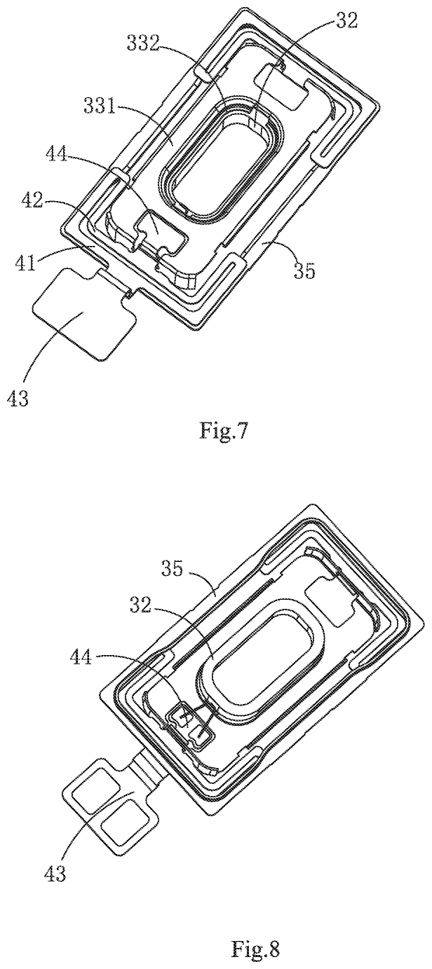

FIG. 7 is an isometric view of an assembly of a steel ring, a FPC, a coil frame and a coil of the speaker box in FIG. 1.

FIG. 8 is an isometric view of an assembly of a steel ring, a FPC, a coil frame and a coil of the speaker box in FIG. 1.

### EMBODIMENT OF DISCLOSURE

### Embodiments of the Present Disclosure

The technical solutions in embodiments of the present disclosure will be described clearly and completely below with reference to the accompanying drawings in the embodiments of the present disclosure.

Please refer to FIGS. 1-8 together, a speaker box 100 provided by an exemplary embodiment of the present disclosure includes a housing 1 with a receiving space 10, a magnet unit 2 and a vibration unit 3 both received in the receiving space 10.

The housing 1 includes a bottom wall 11, a side wall 12 bending and extending from the bottom wall 11, and a top cover 13 covering the side wall 12; the bottom wall 11, the side wall 12 and the top cover 13 encloses the receiving space 10 jointly. Specifically, a sound hole 131 is provided on the top cover 13 to transmit the sound generated by the vibration unit 3 outside.

The magnet unit 2 includes a yoke 21 fixed to the bottom wall 11, a main magnet 22 located in a central position of the bottom wall 11 and a side magnet 24 spaced apart from the main magnet 22 to form a magnetic gap 23. In this embodiment, the magnet unit 2 includes four side magnets 24 annularly surrounding the main magnet 22. Furthermore, for improving the magnetic performance of the magnet unit 2, the magnet unit 2 further includes a first magnetic plate 25 located on a side of the main magnet 22 away from the yoke 21, a top magnet 26 located on a side of the first magnetic plate 25 away from the main magnet 22, and a second magnetic plate 27 located on a side of the side magnet 24 away from the yoke 21.

The vibration unit 3 includes a first diaphragm 31 fixed to the top cover 13, a coil 22 fixed to the first diaphragm 31, a coil frame 33 configured to suspend the coil 22 to insert coil 22 in the magnetic gap 23, a second diaphragm 34 opposite to the first diaphragm 31, and a steel ring 35 configured to fix the second diaphragm 34 to the side wall 12. Specifically, the coil frame 23 is fixed to a side of the first diaphragm 31 facing the magnet unit 2.

Specifically, as shown in FIG. 2-FIG. 6, the coil frame 33 includes a plate portion 331 in a ring shape fixed to the first diaphragm 31, a first support portion 332 bending from an inner edge of the plate portion 331 and configured to suspend the coil 32 inside the magnetic gap 23, and a second support portion 333 bending from an outer edge of the plate portion 331. The steel ring 34 surrounds the second support portion 333. Moreover, an inner edge of the second diaphragm 34 is fixed to the end of the second support portion 333 away from the first diaphragm 31, and an outer edge of the second diaphragm 34 is fixed to the steel ring 35. In the present disclosure, the steel ring 35, the second diaphragm 34 and the coil frame 33 are integrally thermal press molded to form a single component in the assembly process of the speaker box 100. In this way, not only simplify the assembly procedures, but also avoid the risk of that the glue overflows to the second diaphragm in the related art, thus effectively improving the reliability of the second diaphragm and the acoustic performance of the speaker box.

Furthermore, as shown in FIG. 4, the steel ring 35 includes a first horizontal portion 351 fixed to the side wall 12 and a first bending portion 352 bending from an inner edge of the first horizontal portion 351 and extending away from the first diaphragm 31; the outer edge of the second diaphragm 34 is fixed to the first bending portion 352. It can be seen that the first bending portion 352 extends along a vibration direction of the first diaphragm 31. Compared with related art, the fixation of the second diaphragm 34 and the first bending portion 352 reduces a width of their glue area, thus ensuring enough bond strength. In this embodiment, the housing 1 and the coil 32 are both in a rectangle shape. Accordingly, the plate portion 331 of the coil frame 33 is in a rectangle shape; there are two second diaphragms 34 arranged along a short axis of the housing 1; and the second support portion 333 extends along a short axis of the plate portion 331.

To electrically activate the coil 22, the speaker box 100 further includes a FPC 4 electrically connecting the coil 22 and an outer circuit (not shown). Specifically, the FPC 4 is fixed to the first horizontal portion 351 facing the first diaphragm 31. The FPC 4 includes a first elastic portion 41 fixed to the steel ring 35, a second elastic portion 42 spaced apart from the first elastic portion 41, a first electrical connection portion 43 extending from the first elastic portion 41 and a second electrical connection portion 44 extending from the second elastic portion 42; the first electrical connection portion 43 is electrically connected with the outer circuit (not shown); the second electrical connection 44 portion is electrically connected with the coil 22. In the present disclosure, the FPC is no longer fixed to the second diaphragm, the first elastic portion 41 of the FPC 4 is fixed to the first horizontal portion 351, thus effectively ensuring the glue area between the steel ring and the FPC and accordingly improving their bond strength and vibration stability of the speaker box. It can be understood that the speaker box 100 includes two FPCs 4 arranged corresponding to the second diaphragm 34. In this embodiment, only one FPC 4 includes the first electrical connection portion 43 and the second electrical connection portion 44.

As shown in FIGS. 4-8, to make the coil 32 be prone to connect with the FPC 4, a first through hole 3331 is provided on the second support portion 333 of the coil frame 33; and the first through hole 3331 extends from the second support portion 333 to the plate portion 331. Then, the second electrical connection portion 44 extends through the first through hole 3331 to be electrically connected with the coil 32. The first electrical connection portion 43 extends outside the speaker box 100 through a notch on the side wall 12.

Moreover, the first diaphragm 31 includes a central diaphragm 311 located in a central position, a dome 312 surrounding the central diaphragm 311 and a side diaphragm 313 surrounding the dome 312. The side diaphragm 313 is fixed to the side wall 12 of the housing 1. The plate portion 331 of the coil frame 33 is fixed to a side of the dome 312 facing the coil 32. The central diaphragm 311 is fixed to a side of the top magnet 26 away from the first magnetic plate 25.

Additionally, the speaker box 100 further includes a three dimensional mesh 5 in an annular shape. One end of the three dimensional mesh 5 surrounds the side magnet 34, the other end of the three dimensional mesh 5 is fixed to the bottom wall 11. The three dimensional mesh 5 is spaced apart from the bottom wall 11 to form a cavity for filling sound absorption material.

Compared with the related art, in the speaker box of the present disclosure, the steel ring, the second diaphragm and the coil frame are integrally thermal press molded to form a single component in the assembly process of the speaker box. In this way, not only simplify the assembly procedures, but also avoid the risk of that the glue overflows to the second diaphragm in the related art, thus effectively improving the reliability of the second diaphragm and the acoustic performance of the speaker box.

The above are only embodiments of the present disclosure. It should be pointed out that those of ordinary skilled in the art may also make improvements without departing from the ideas of the present disclosure, all of which fall within the protection scope of the present disclosure.

1. A speaker box comprising:
a housing with a receiving space;
a magnet unit having a magnetic gap, comprising:
a yoke fixed to the housing; and
a main magnet fixed to the yoke;
a vibration unit received in the receiving space, comprising:
a first diaphragm fixed to the housing;
a coil fixed to the first diaphragm and inserted in the magnetic gap;
a coil frame configured to suspend the coil, comprising:
a plate portion in a ring shape fixed to the first diaphragm;
a first support portion bending from an inner edge of the plate portion and configured to suspend the coil inside the magnetic gap; and
a second support portion bending from an outer edge of the plate portion;
a steel ring fixed the housing and surrounding the second support portion; and
a second diaphragm connecting the steel ring and an end of the second support portion away from the first diaphragm;
wherein the steel ring, the second diaphragm and the coil frame are integrally molded.

2. The speaker box as described in claim 1, wherein an inner edge of the second diaphragm is fixed to the end of the second support portion away from the first diaphragm, and an outer edge of the second diaphragm is fixed to the steel ring.

3. The speaker box as described in claim 1, further comprising a FPC electrically connecting the coil and an outer circuit and fixed to a side of the steel ring facing the first diaphragm.

4. The speaker box as described in claim 3, wherein the steel ring comprises a first horizontal portion fixed to the housing and a first bending portion bending from an inner edge of the first horizontal portion and extending away from the first diaphragm; the outer edge of the second diaphragm is fixed to the first bending portion; the FPC is fixed to a side of the first horizontal portion facing the first diaphragm.

5. The speaker box as described in claim 4, wherein the FPC comprises a first elastic portion fixed to the steel ring, a second elastic portion spaced apart from the first elastic portion, a first electrical connection portion extending from the first elastic portion and a second electrical connection portion extending from the second elastic portion, the second electrical connection portion is electrically connected with the coil.

6. The speaker box as described in claim 5, wherein a first through hole is provided on the second support portion of the coil frame; the second electrical connection portion extends through the first through hole to be electrically connected with the coil.

7. The speaker box as described in claim 6, wherein the first diaphragm comprises a central diaphragm located in a central position, a dome surrounding the central diaphragm and a side diaphragm surrounding the dome; the side diaphragm is fixed to the housing; the plate portion of the coil frame is fixed to a side of the dome facing the coil.

8. The speaker box as described in claim 7, wherein the magnet unit further comprises a side magnet spaced apart from the main magnet to form the magnetic gap; the central diaphragm is fixed to a side of the main magnet away from the yoke.

9. The speaker box as described in claim 8, wherein the housing is in a rectangle shape, the second diaphragm is arranged along a short axis of the housing.

10. The speaker box as described in claim 1, wherein the steel ring, the second diaphragm and the coil frame are integrally thermal press molded.
